(19) United States
(12) Patent Application Publication
(10) Pub. No.: US 2025/0256518 A1
(43) Pub. Date: Aug. 14, 2025

(54) DRYING DEVICE AND RECORDING DEVICE

(71) Applicant: SEIKO EPSON CORPORATION, Tokyo (JP)

(72) Inventor: Tadashi AIZAWA, MATSUMOTO-SHI (JP)

(21) Appl. No.: 19/046,830

(22) Filed: Feb. 6, 2025

(30) Foreign Application Priority Data
Feb. 8, 2024 (JP) 2024-017760

(51) Int. Cl. B41J 11/00

(52) U.S. Cl. CPC B41J 11/00212; B41J 11/00218; B41J 11/007

(57) ABSTRACT

A drying device include a drying section that dries a medium onto which pigment ink containing a pigment, water, and a solvent was ejected by generating an electromagnetic wave in response to application of a high-frequency voltage. The drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode. The drying section generates electromagnetic waves so that an irradiation intensity of the electromagnetic wave on a medium onto which pigment ink was ejected becomes pulsed in time series.

The present application is based on, and claims priority from JP Application Serial Number 2024-017760, filed Feb. 8, 2024, the disclosure of which is hereby incorporated by reference herein in its entirety.

### BACKGROUND

### 1. Technical Field

The present disclosure relates to a drying device and a recording device.

### 2. Related Art

For example, JP-A-2017-16742 discloses a drying device that dries a medium by generating electromagnetic waves on the medium onto which liquid was ejected. As the liquid, pigment ink may be used. Pigment ink includes a pigment, water, and a solvent, and the solvent may include, for example, glycerin.

Such a drying device generates a high-intensity electromagnetic wave in a medium by supplying a high-frequency voltage between a first electrode and a second electrode. By this, the medium can be dried in a short time by boiling liquid ejected onto the medium regardless of whether or not the surrounding of the medium is saturated with water vapor.

However, in such a drying device, since a high-intensity electromagnetic wave is generated, there is a possibility that thermal denaturation may occur with respect to the medium. Therefore, it is desired to dry the medium in a short time while maintaining the quality of the medium.

### SUMMARY

A drying device to overcome the above-described problem includes a drying section that dries a medium onto which pigment ink containing a pigment, water, and a solvent was ejected by generating an electromagnetic wave in response to application of a high-frequency voltage, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode and the drying section generates electromagnetic waves so that an irradiation intensity of the electromagnetic wave on a medium onto which pigment ink was ejected becomes pulsed in time series.

A recording device to overcome the above-described problem includes a recording section that performs recording by ejecting pigment ink containing a pigment, water, and a solvent onto a medium and a drying section that dries a medium onto which pigment ink was ejected by the recording section by generating an electromagnetic wave in response to application of a high-frequency voltage, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode and the drying section generates electromagnetic waves so that an irradiation intensity of the electromagnetic wave on a medium onto which pigment ink was ejected becomes pulsed in time series.

### BRIEF DESCRIPTION OF THE DRAWINGS

FIG. 1 is a schematic diagram showing a recording system of a first embodiment.

FIG. 2 is a top view showing a drying section of the first embodiment.

FIG. 3 is a perspective view showing the drying section of the first embodiment.

FIG. 4 is a flowchart showing a drying control process of the first embodiment.

FIG. 5 is an explanatory diagram showing an intensity of an electromagnetic wave in a medium and temperature in the medium of the first embodiment.

FIG. 6 is a top view showing a drying section of a second embodiment.

FIG. 7 is an explanatory diagram showing an intensity of electromagnetic waves in a medium of the second embodiment.

FIG. 8 is a top view showing a drying section of a third embodiment.

FIG. 9 is an explanatory diagram showing an intensity of an electromagnetic wave in a medium of the third embodiment.

### DESCRIPTION OF EMBODIMENTS

### First Embodiment

Hereinafter, an embodiment of a recording system including a drying device and a recording device will be described. In the following description, a direction intersecting a vertical direction Z is referred to as a width direction X, and a direction intersecting the vertical direction Z and the width direction X is referred to as a depth direction Y. One direction along the width direction X is referred to as a first width direction X1, and the other direction along the width direction X is referred to as a second width direction X2. One direction along the depth direction Y is referred to as a first depth direction Y1, and the other direction along the depth direction Y is referred to as a second depth direction Y2. In the vertical direction Z, an upper direction is referred to as an upper direction Z1, and a lower direction is referred to as a lower direction Z2. The vertical direction Z corresponds to an example of a first direction.

### Configuration of Recording System 10

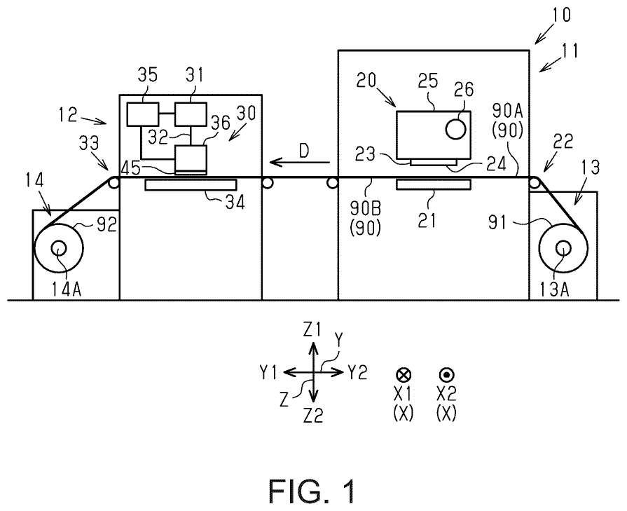

As shown in FIG. 1, a recording system 10 is a system that performs recording on a medium 90. In particular, the recording system 10 is a system that performs recording on the medium 90 by ejecting liquid onto the medium 90. The recording system 10 is a system that dries the medium 90 on which recording has been performed by ejecting liquid.

The liquid is pigment ink. Pigment ink includes a pigment, water, and a solvent. The solvent may include, for example, glycerin. Glycerin is a solvent for preventing clogging of a nozzle that ejects liquid. Due to the vaporization of glycerin, the abrasion resistance of the medium 90 onto which pigment ink was ejected is improved.

The recording system 10 includes a recording device 11. The recording device 11 is configured to perform recording on the medium 90. In particular, the recording device 11 performs recording on the medium 90 by ejecting liquid onto the medium 90. The recording device 11 may be an inkjet type printer that performs recording by ejecting pigment ink as liquid onto the medium 90. The medium 90 includes a front surface 90A and a back surface 90B. The medium 90 is fabric, but may be, for example, paper.

The recording system 10 includes a drying device 12. The drying device 12 is configured to dry the medium 90 after recording onto which the recording device 11 has ejected liquid. In particular, the drying device 12 generates an electromagnetic wave to dry the medium 90 after recording.

The recording system 10 includes a feeding section 13. The feeding section 13 feeds the medium 90 before recording to the recording device 11. The feeding section 13 includes a feed roller 13A. The feed roller 13A extends along the width direction X. In the width direction X, the width of the feed roller 13A is longer than the width of the medium 90. The feed roller 13A is configured to rotatably hold a first roll body 91. The first roll body 91 is the medium 90 before recording that is wound and stacked. The medium 90 may be elongated. In this way, the feed roller 13A holds the medium 90 to be fed to the recording device 11.

The recording system 10 includes a winding section 14. The winding section 14 winds up the medium 90 after recording by the recording device 11. In particular, the winding section 14 winds up the medium 90 after recording and drying by the drying device 12. The winding section 14 includes a winding roller 14A. The winding roller 14A extends along the width direction X. In the width direction X, the width of the winding roller 14A is longer than the width of the medium 90. The winding roller 14A is configured to rotatably hold a second roll body 92. The second roll body 92 is the medium 90 after recording that is wound and stacked. In this way, the winding roller 14A winds up the medium 90 that was recorded by the recording device 11 and dried by the drying device 12.

### Configuration of Recording Device 11

Here, the configuration of the recording device 11 will be described in detail.

The recording device 11 includes a recording section 20, a recording support section 21, and a recording transport section 22. The recording section 20 is configured to perform recording on the medium 90 by ejecting liquid onto the medium 90. The recording section 20 is configured to perform recording on the medium 90 by ejecting liquid onto the front surface 90A of the medium 90. The recording section 20 performs recording on the medium 90 supported by the recording support section 21. The recording section 20 performs recording on the medium 90 transported by the recording transport section 22.

The recording section 20 includes a head 23. The head 23 may be a serial head or may be a line head. A serial head is a head that scans in the width direction X of the medium 90. A line head is a head that records simultaneously across the width direction X of the medium 90.

The head 23 includes a nozzle surface 24 in which a plurality of nozzles (not shown) are opened. The nozzle surface 24 is a surface facing the lower direction Z2. The nozzle surface 24 is a surface facing the front surface 90A of the medium 90 transported by the recording transport section 22. Each of the plurality of nozzles is configured to open up in the lower direction Z2. Each of the plurality of nozzles is configured to eject liquid.

The recording section 20 may include a carriage 25 and a carriage support section 26. The carriage 25 is configured to support the head 23. The carriage support section 26 extends along the width direction X. The carriage support section 26 supports the carriage 25 so as to be movable along the width direction X. The carriage 25 is movable in the width direction X along the carriage support section 26 by a driving force from a drive source (not shown).

The recording support section 21 is configured to support the medium 90 transported by the recording transport section 22. The recording support section 21 is positioned in the lower direction Z2 of the recording section 20. The recording support section 21 supports the back surface 90B of the medium 90 transported by the recording transport section 22. The recording support section 21 is positioned in the lower direction Z2 of the head 23.

The recording transport section 22 is configured to transport the medium 90 in a transport direction D. The transport direction D is a direction along the depth direction Y. The recording transport section 22 may include a plurality of rollers. Although the recording transport section 22 transports the medium 90 in the transport direction D using the plurality of rollers, the recording transport section 22 may transport the medium 90 in the transport direction D using a transport belt driven by a plurality of rollers. The recording transport section 22 may perform intermittent transport in which the transport and stop of the medium 90 are repeated.

### Configuration of Drying Device 12

Next, the configuration of the drying device 12 will be described in detail.

The drying device 12 includes a drying unit 30. The drying unit 30 is configured to dry the medium 90 after recording. That is, the drying device 12 sets the medium 90 on which recording is performed by the recording section 20 as an object to be dried.

The drying unit 30 is configured to dry the medium 90 after recording by generation of electromagnetic waves. The drying unit 30 is positioned in the upper direction Z1 of the medium 90, but may be positioned in the lower direction Z2 of the medium 90, or may be positioned both in the upper direction Z1 and in the lower direction Z2 of the medium 90. In this way, the vertical direction Z is a direction toward the medium 90.

The drying device 12 includes a high-frequency voltage generation section 31. The high-frequency voltage generation section 31 is configured to generate a high-frequency voltage. The high-frequency voltage generation section 31 supplies a high-frequency voltage to the drying unit 30 through a transmission line 32.

The transmission line 32 is a line for connecting the drying unit 30 and the high-frequency voltage generation section 31. The transmission line 32 is capable of transmitting a high-frequency voltage from the high-frequency voltage generation section 31 to the drying unit 30. That is, the transmission line 32 is capable of transmitting a high-frequency voltage.

The transmission line 32 may be a coaxial cable, but is not limited to coaxial cable. The transmission line 32 may include a first line and a second line. The first line may be a core line of the transmission line 32. The second line may be an electromagnetic shield that covers the first line.

The drying device 12 includes a drying transport section 33. The drying transport section 33 is configured to transport the medium 90 in the transport direction D. The drying transport section 33 may transport the medium 90 in the transport direction D using a plurality of rollers. The drying transport section 33 transports the medium 90 in the transport direction D at a predetermined speed. The drying transport section 33 performs intermittent transport in which the transport and stop of the medium 90 are repeated. Slackening of the medium 90 may occur between the recording transport section 22 and the drying transport section 33.

The drying device 12 includes a drying support section 34. The drying support section 34 is configured to support the medium 90 transported by the drying transport section 33. The drying support section 34 is positioned in the lower direction Z2 of the drying unit 30. The drying support section 34 supports the back surface 90B of the medium 90 transported by the drying transport section 33. The drying support section 34 is positioned in the lower direction Z2 of the drying section 36 (to be described later).

The drying device 12 includes a control section 35. The control section 35 controls the drying device 12. Specifically, the control section 35 controls the drying unit 30. The control section 35 controls the high-frequency voltage generation section 31. The control section 35 controls the drying transport section 33.

The control section 35 may be constituted by one or more processors that execute various processes in accordance with a computer program. The control section 35 may be composed of one or more dedicated hardware circuits. The control section 35 may be configured with an application specific integrated circuit that executes at least a part of various processes. The control section 35 may be composed of a processor and a circuit including a combination of hardware circuits. The processor includes a CPU and memories such as a RAM and a ROM. The memory stores program codes or instructions configured to cause the CPU to perform processes. Memory, that is computer-readable medium, includes any readable medium that can be accessed by a general-purpose or dedicated computer.

The drying unit 30 includes a drying section 36. That is, the drying device 12 includes the drying section 36. The drying unit 30 may include a plurality of drying sections 36. The drying section 36 may be rectangular in plan view from the vertical direction Z. The drying section 36 may be arranged so that the width direction X is a longitudinal direction. Hereinafter, a plan view from the vertical direction Z is simply referred to as plan view.

The drying section 36 is configured to generate an electromagnetic wave in response to application of a high-frequency voltage. The drying section 36 generates an electromagnetic wave in response to application of a high-frequency voltage. By this, the drying section 36 is configured to dry the medium 90 onto which liquid was ejected by the recording section 20. The drying section 36 is an electromagnetic wave generation section.

The drying section 36 generates an alternating current electric field by generating an electromagnetic wave. An electromagnetic wave generated by the drying section 36 has an electric field as a main component. The drying section 36 can significantly reduce induction of a magnetic field due to a generated electric field as compared with an electromagnetic wave generation section that generates a normal electromagnetic wave.

As a specific example, the drying section 36 generates electromagnetic waves of 2.4 GHz, but is not limited to this. The drying section 36 may generate, for example, electromagnetic waves of 3 MHz to 300 MHz. The drying section 36, for example, may generate electromagnetic waves of 300 MHz to 30 GHZ, and among these, may generate electromagnetic waves of 10 MHz to 20 GHZ.

The drying section 36 dries the medium 90 by heating the medium 90 from the front surface 90A. Specifically, the drying section 36 heats liquid ejected onto the medium 90 from the front surface 90A. The drying section 36 dries the medium 90 by vaporizing liquid ejected onto the medium 90. That is, the drying section 36 is a method of drying the medium 90 regardless of whether or not water vapor is saturated around the medium 90. Therefore, the drying section 36 does not need to blow dry gas in which water vapor is not saturated around the medium 90.

### Arrangement of Drying Section 36

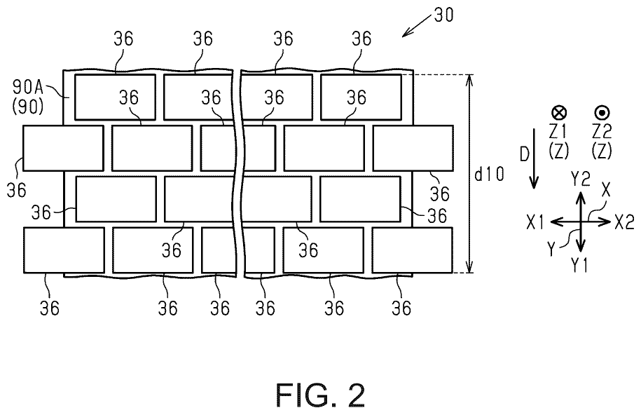

As shown in FIG. 2, when the drying unit 30 includes a plurality of drying sections 36, the plurality of drying sections 36 may be arranged in the width direction X, and the plurality of drying sections 36 may be arranged in the depth direction Y. In this case, the plurality of drying sections 36 may be arranged across the entire width of the medium 90 in the width direction X. A plurality of drying sections 36 may be arranged over a distance d10 in the depth direction Y. Thus, a region of the medium 90 facing the plurality of the drying sections 36 corresponds to a region to be dried.

### Configuration of Drying Section 36

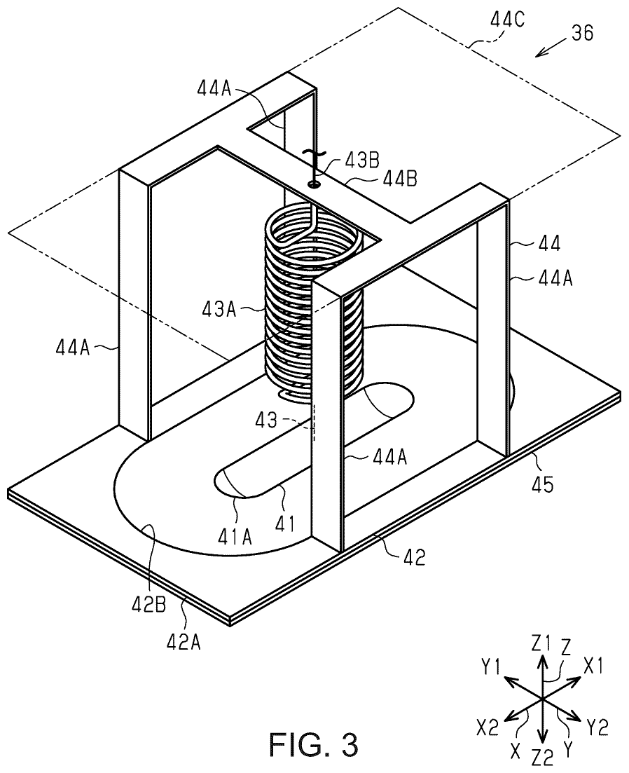

As shown in FIG. 3, the drying section 36 includes a first electrode 41, a second electrode 42, a first conductor 43, and a second conductor 44. The drying section 36 may include a facing section 45. FIG. 2 is a view in which the first electrode 41 and second electrode 42 are arranged on a lower direction Z2 side.

The first electrode 41 has a flat plate shape. The first electrode 41 is elongated in the width direction X in plan view. That is, the first electrode 41 extends in the width direction X in plan view. The first electrode 41 may have a rectangular shape in plan view.

The first electrode 41 includes a first electrode surface 41A. The first electrode surface 41A is a surface facing the lower direction Z2. That is, the first electrode surface 41A is a surface facing the front surface 90A of the medium 90. The first electrode 41 is arranged such that the first electrode surface 41A abuts the facing section 45.

The second electrode 42 has a flat plate shape. The second electrode 42 includes a second electrode surface 42A. The second electrode surface 42A is a surface facing the lower direction Z2. That is, the second electrode surface 42A is a surface facing the front surface 90A of the medium 90. The second electrode 42 is arranged such that the second electrode surface 42A abuts the facing section 45.

The second electrode 42 includes an opening section 42B. The opening section 42B has a rounded rectangular shape in plan view, but may have a rectangular shape. The first electrode 41 is positioned in the opening section 42B in plan view. That is, the second electrode 42 is arranged so as to surround the first electrode 41 in plan view.

The first conductor 43 is configured to electrically connect the transmission line 32 and the first electrode 41. The first conductor 43 includes a coil 43A. The coil 43A extends in the vertical direction Z. One end of the coil 43A is connected to the first electrode 41. The other end of the coil 43A is connected to a conductor wire 43B.

The second conductor 44 is configured to electrically connect the transmission line 32 and the second electrode 42. The second conductor 44 may include a columnar support 44A. The second conductor 44 may include a plurality of columnar supports 44A. The columnar supports 44A are electrically connected to the second electrode 42. The columnar support 44A extends from the second electrode 42 in the upper direction Z1. The columnar support 44A is made of metal.

The second conductor 44 may include a connection section 44B. The connection section 44B is electrically connected to the columnar supports 44A. The connection section 44B is provided at an upper end section of the columnar support 44A. The connection section 44B connects a plurality of columnar supports 44A. The connection section 44B may be integral with the columnar support 44A. The connection section 44B may be H-shaped in plan view. The connection section 44B is made of metal.

The second conductor 44 may include a top plate 44C. The top plate 44C is positioned in the upper direction Z1 of the connection section 44B. The top plate 44C is electrically connected to the connection section 44B. The top plate 44C may be integral with the connection section 44B. The top plate 44C is made of metal.

The facing section 45 is positioned between the first electrode 41 and the second electrode 42, and the medium 90. The facing section 45 may have a flat plate shape. The facing section 45 is made of a material that transmits electromagnetic waves generated by the drying section 36. The facing section 45 is arranged so as to face the front surface 90A of the medium 90. The facing section 45 may not be in contact with the medium 90, and may be in contact with the medium 90. The facing section 45 protects the first electrode 41 and the second electrode 42. The facing section 45 is composed of a member having insulating properties. The facing section 45 may be a glass plate. The facing section 45 may be a ceramic with high transmittance. The facing section 45 may be made of a resin with a low dissipation factor. The facing section 45 may be made of polypropylene. The facing section 45 may be made of polyethylene.

By configuring the drying section 36 in this manner, when a high-frequency voltage is applied, the first electrode 41 and the second electrode 42 heat the medium 90 by generating an electromagnetic wave in response to application of a high-frequency voltage.

Such a drying section 36 can transmit a large amount of thermal energy to the medium 90 due to generation of electromagnetic waves. The drying section 36 is not of a thermal conduction type but of an electromagnetic wave type, and does not need to include a member such as a heating wire for heating. This allows the drying section 36 to be made smaller in size.

The minimum separation distance between the first electrode 41 and the second electrode 42 is equal to or less than 1/10 of the wavelength of an electromagnetic wave output from the drying section 36. By this, electromagnetic waves generated when a high-frequency voltage is applied can be attenuated in the vicinity of the first electrode 41 and the second electrode 42. By this, it is possible to reduce the intensity of an electromagnetic wave that reaches a distant place from the first electrode 41 and the second electrode 42. That is, an electromagnetic wave generated from the drying section 36 is very strong in the vicinity of the first electrode 41 and the second electrode 42, and is very weak in a distant place.

Such a drying section 36 can intensively generate an alternating current electric field in the vicinity of the first electrode 41 and the second electrode 42 by appropriately controlling the frequency band of an electromagnetic wave to be generated. In other words, it is possible to suppress the influence on the surroundings accompanying the generation of electromagnetic waves beyond the vicinity of the first electrode 41 and the second electrode 42. The vicinity of the first electrode 41 and the second electrode 42 may correspond to a range of, for example, 3 mm to 3 cm.

### Drying Control Process

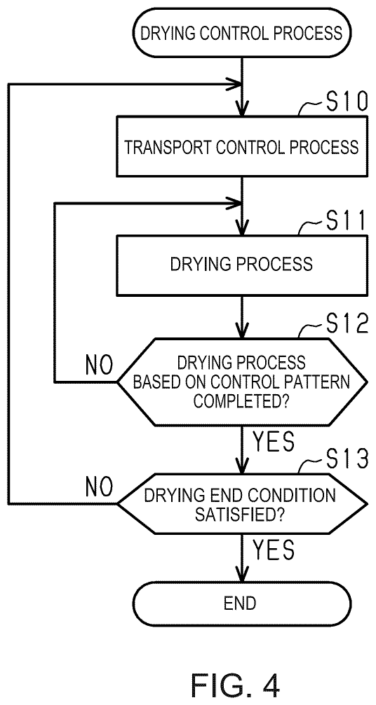

Here, a drying control process will be described with reference to FIG. 4. The drying control process is a process executed by the control section 35 when there is a drying instruction from a user.

As shown in FIG. 4, in step S10, the control section 35 executes a transport control process. In this process, the control section 35 controls the drying transport section 33 so as to transport the medium 90 in the transport direction D. In particular, the control section 35 performs intermittent transport in which the transport of the medium 90 is stopped for a predetermined time after the medium 90 is transported in the transport direction D by the distance d10.

The distance d10 is a distance at which the drying section 36 is arranged in the transport direction D. That is, the distance d10 is a distance corresponding to a region to be dried for drying the medium 90. The predetermined time is a time corresponding to a control pattern of the drying section 36. The control pattern is a pattern for controlling drying section 36. The control pattern is a pattern in which the drying section 36 generates an electromagnetic wave.

In step S11, the control section 35 executes a drying process. In this process, the control section 35 controls the high-frequency voltage generation section 31 to supply a high-frequency voltage to the drying section 36. By this, the control section 35 controls the high-frequency voltage generation section 31 to drive the drying section 36.

In particular, the control section 35 controls the high-frequency voltage generation section 31 so as to drive the drying section 36 based on the control pattern. By this, the drying section 36 generates an electromagnetic wave based on the control pattern in a state in which the transport of the medium 90 is stopped.

In step S12, control section 35 determines whether the drying process based on the control pattern is completed or not. In a case where the control section 35 determines that the drying process based on the control pattern is not completed, the control section 35 shifts the process to step S11. In a case where the control section 35 determines that the drying process based on the control pattern is completed, the control section 35 shifts the process to step S13.

In step S13, the control section 35 determines whether a drying end condition is satisfied or not. The drying end condition may be satisfied when there is a drying end instruction from a user. The drying end condition may be satisfied when a predetermined time has elapsed.

In a case where the control section 35 determines that the drying end condition is not satisfied, the control section 35 shifts the process to step S10. When the control section 35 determines that the drying end condition is satisfied, the control section 35 controls the drying transport section 33 to stop the transport of the medium 90 and controls the high-frequency voltage generation section 31 to stop the supply of a high-frequency voltage to the drying section 36. Thereafter, the control section 35 ends the drying control process.

As described above, until the drying end condition is satisfied, the control section 35 repeatedly executes the transport control process for transporting the medium 90 in the transport direction D by the distance d10, and then executes the drying process based on the control pattern for a region to be dried in a state where the transport of the medium 90 is stopped.

### Control Pattern

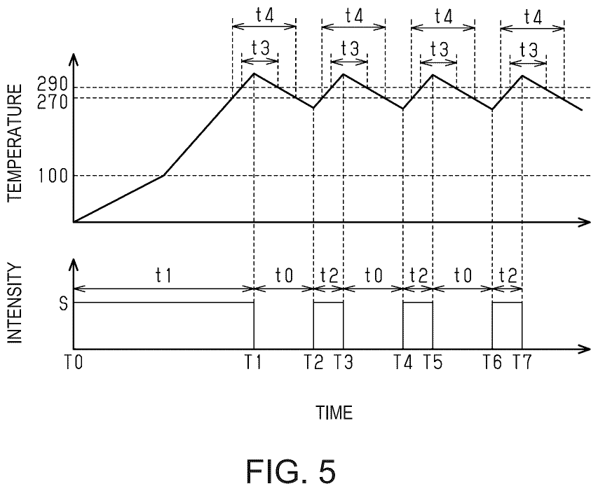

Next, a control pattern for controlling the drying section 36 will be described with reference to FIG. 5.

As shown in FIG. 5, the control pattern is a pattern in which the intensity of an electromagnetic wave generated from the drying section 36 is intensity S from the timing indicated by the reference symbol T0 to the timing indicated by the reference symbol T1. The time t1 from the timing indicated by the reference symbol T0 to the timing indicated by the reference symbol T1 may be, for example, 3 seconds. As described above, the control pattern is a pattern in which an electromagnetic wave is generated from the timing indicated by the reference symbol T0 over a first pulse width of the time t1. The timing indicated by the reference symbol T0 corresponds to an example of a first start timing.

The control pattern is a pattern in which an electromagnetic wave is not generated from the drying section 36 from the timing indicated by the reference symbol T1 to the timing indicated by the reference symbol T2. The time to from the timing indicated by the reference symbol T1 to the timing indicated by the reference symbol T2 may be, for example, 1 second. The time to is shorter than the time t1.

The control pattern is a pattern in which the intensity of an electromagnetic wave generated from the drying section 36 is the intensity S from the timing indicated by reference symbol T2 to the timing indicated by reference symbol T3. The time t2 from the timing indicated by reference symbol T2 to the timing indicated by reference symbol T3 may be, for example, 0.5 seconds. The time t2 is shorter than the time to and the time t1. As described above, the control pattern is a pattern in which an electromagnetic wave is generated from the timing indicated by the reference symbol T2 over a second pulse width of the time t2. The timing indicated by reference symbol T2 corresponds to an example of a second start timing.

The control pattern is a pattern in which an electromagnetic wave is not generated from the drying section 36 from the timing indicated by the reference symbol T3 to the timing indicated by the reference symbol T4 and from the timing indicated by the reference symbol T5 to the timing indicated by the reference symbol T6. The time to from the timing indicated by the reference symbol T3 to the timing indicated by the reference symbol T4, and the time to from the timing indicated by the reference symbol T5 to the timing indicated by the reference symbol T6, may be the same as the time to from the timing indicated by the reference symbol T1 to the timing indicated by the reference symbol T2.

The control pattern is a pattern in which the intensity of an electromagnetic wave generated from the drying section 36 is the intensity S from the timing indicated by the reference symbol T4 to the timing indicated by the reference symbol T5 and from the timing indicated by the reference symbol T6 to the timing indicated by the reference symbol T7. The time t2 from the timing indicated by the reference symbol T4 to the timing indicated by the reference symbol T5 and the time t2 from the timing indicated by the reference symbol T6 to the timing indicated by the reference symbol T7 may be the same as the time t2 from the timing indicated by the reference symbol T2 to the timing indicated by the reference symbol T3. As described above, the control pattern is a pattern in which an electromagnetic wave is generated from the timing indicated by the reference symbols T4 and T6 over the second pulse width of the time t2.

The control pattern is a pattern in which an electromagnetic wave is generated for the time t1, then not generated for the time to, and then generated for the time t2, and this sequence is repeated over three cycles.

In this manner, the drying section 36 generates an electromagnetic wave with respect to the medium 90 so that the intensity of the electromagnetic wave to be generated becomes pulsed in time series. In a state where the transport of medium 90 is stopped, the intensity of an electromagnetic wave generated by drying section 36 corresponds to the irradiation intensity of an electromagnetic wave in the medium 90. In other words, the drying section 36 generates an electromagnetic wave so that the irradiation intensity of the electromagnetic wave in the medium 90 becomes pulsed in time series.

### Drying Principle of Medium 90

Pigment ink as liquid is ejected onto the medium 90 by the recording device 11. Unlike dye ink that permeates into the medium 90, pigment ink is fixed on the front surface 90A of the medium 90 to perform recording.

Pigment ink contains water in addition to a pigment. Pigment ink contains glycerin as a solvent. When the temperature of pigment ink reaches approximately 100° C., water contained in pigment ink is vaporized. When the temperature of pigment ink reaches approximately 290° C., glycerin contained in pigment ink is vaporized.

Pigment ink ejected onto the front surface 90A of the medium 90 is heated by an electromagnetic wave generated from the drying section 36. By this, water and a solvent contained in pigment ink are vaporized, whereby the medium 90 is dried. In particular, since glycerin contained in pigment ink is vaporized, the abrasion resistance of the medium 90 can be improved.

An electromagnetic wave generated from the drying section 36 does not heat gas around the medium 90. Therefore, an electromagnetic wave does not directly heat the medium 90 itself but heats pigment ink. As described above, the generation of an electromagnetic wave itself does not directly cause thermal denaturation of the medium 90. On the other hand, when pigment ink is heated by the generation of an electromagnetic wave, the heat of pigment ink is transferred to medium 90. This may cause thermal denaturation of medium 90.

For example, in a case where the type of medium 90 is a cotton cloth, when a state in which the temperature of the medium 90 is approximately 270° C. continues for 1 second, thermal denaturation with respect to medium 90 occurs. Thermal denaturation of the medium 90 includes a property that medium 90 changes to yellow. In addition, when the temperature of the medium 90 exceeds 400° C., there is a risk of ignition, and it is necessary to prevent the temperature of the medium 90 from exceeding approximately 350° C.

As described above, when the medium 90 on which pigment ink is ejected is dried, it is necessary to raise the temperature of pigment ink to 290° C. or higher. On the other hand, it is necessary to dry the medium 90 so that the temperature of the medium 90 does not exceed approximately 350° C. and the temperature of the medium 90 does not exceed approximately 270° C. continuously for 1 second.

As shown in FIG. 5, when the drying section 36 generates an electromagnetic wave based on a control pattern, the temperature of the medium 90 increases from the timing indicated by the reference symbol T0 and reaches approximately 100° C. In this manner, by rapidly increasing the temperature of the medium 90 from the timing indicated by the reference symbol T0, water contained in pigment ink is vaporized, and thus provisional drying is performed. Then, the temperature becomes approximately 310° C. at the timing indicated by the reference symbol T1.

From the timing indicated by the reference symbol T1, the drying section 36 does not generate an electromagnetic wave. Therefore, the temperature of the medium 90 is lowered to approximately 250° C. at the timing indicated by the reference symbol T2. At this time, the temperature of the medium 90 exceeds approximately 290° C. for the time t3.

Since the drying section 36 generates an electromagnetic wave from the timing indicated by the reference symbol T2, the temperature of the medium 90 rises and reaches approximately 310° C. at the timing indicated by the reference symbol T3. Thereafter, from the timing indicated by the reference symbol T3, the drying section 36 does not generate an electromagnetic wave. Therefore, the temperature of the medium 90 is lowered to approximately 250° C. at the timing indicated by the reference symbol T4.

At this time, the temperature of the medium 90 exceeds approximately 290° C. for the time t3. Also, the temperature of the medium 90 exceeds approximately 270° C. for the time t4. For example, the time t3 may be 0.4 seconds, and the time t4 may be 0.6 seconds.

In this way, from the timing indicated by the reference symbol T0 to the timing indicated by the reference symbol T2, after the temperature of the medium 90 is rapidly increased, the temperature repeatedly exceeds 290° C. for the time t3 and exceeds 270° C. for the time t4 without exceeding about 350° C. Then, drying based on the control pattern is completed at the timing indicated by the reference symbol T7.

By this, main drying is performed by vaporizing a solvent contained in pigment ink without causing thermal denaturation of the medium 90. In particular, in the main drying, an electromagnetic wave is generated over three cycles in order to increase the reliability of vaporization of glycerin. The time from the timing indicated by the reference symbol T0 to the timing indicated by the reference symbol T7 may be, for example, 7.5 seconds.

### Operations and Effects of First Embodiment

Operations and effects of the first embodiment will be described.

(1-1) In the related art, main drying is performed by blowing high temperature hot air or irradiating infrared rays, but it is necessary to perform drying at an appropriate temperature for a long period of time such as 120 seconds, for example, which results in a decrease in drying efficiency and an increase in the size of a system.

Therefore, the drying section 36 generates an electromagnetic wave so that the irradiation intensity of an electromagnetic wave in the medium 90 on which pigment ink is ejected becomes pulsed in time series. According to this configuration, the medium 90 can be dried in a short time by generating an electromagnetic wave in response to application of a high-frequency voltage.

In addition, even if the intensity of an electromagnetic wave is strong, the irradiation intensity of the electromagnetic wave in the medium 90 can become pulsed in time series. By this, it is possible to suppress the occurrence of thermal denaturation with respect to the medium 90 onto which pigment ink was ejected. Therefore, it is possible to dry the medium 90 in a short time while maintaining the quality of the medium 90.

(1-2) The drying section 36 generates an electromagnetic wave based on a control pattern. The control pattern is a pulsed pattern in which an electromagnetic wave is generated over a first pulse width from the timing indicated by the reference symbol T0, and an electromagnetic wave is generated over a second pulse width shorter than the first pulse width from the timing indicated by the reference symbol T2. According to this configuration, the generation timing of an electromagnetic wave can be controlled based on the control pattern. Therefore, the control accuracy of the temperature of pigment ink can be improved.

In particular, by generating an electromagnetic wave over the first pulse width from the timing indicated by the reference symbol T0, it is possible to increase the speed of increasing the temperature of pigment ink ejected onto the medium 90. Then, by generating an electromagnetic wave over the second pulse width that is shorter than the first pulse width from the timing indicated by the reference symbol T2, it is possible to suppress an excessive rise in the temperature of pigment ink ejected onto the medium 90. By this, it is possible to suppress the occurrence of thermal denaturation with respect to the medium 90 onto which pigment ink was ejected. Therefore, it is possible to dry the medium 90 in a short time while maintaining the quality of the medium 90.

(1-3) The drying section 36 generates an electromagnetic wave based on the control pattern when the transport of the medium 90 is stopped. According to this configuration, an electromagnetic wave can be generated based on the control pattern when the transport of medium 90 is stopped. Therefore, the control accuracy of the temperature of pigment ink can be improved. By this, it is possible to suppress the occurrence of thermal denaturation with respect to the medium 90 onto which pigment ink was ejected. Therefore, it is possible to dry the medium 90 in a short time while maintaining the quality of the medium 90.

(1-4) The drying section 36 is provided on a front surface 90A side of the medium 90. Therefore, the medium 90 can be dried by heating liquid from a front surface 90A side of the medium 90 onto which liquid was ejected.

### Second Embodiment

Next, a second embodiment will be described. In the following description, the same configuration as that of the embodiment already described will be omitted or simplified, and a configuration different from that of the embodiment already described will be described.

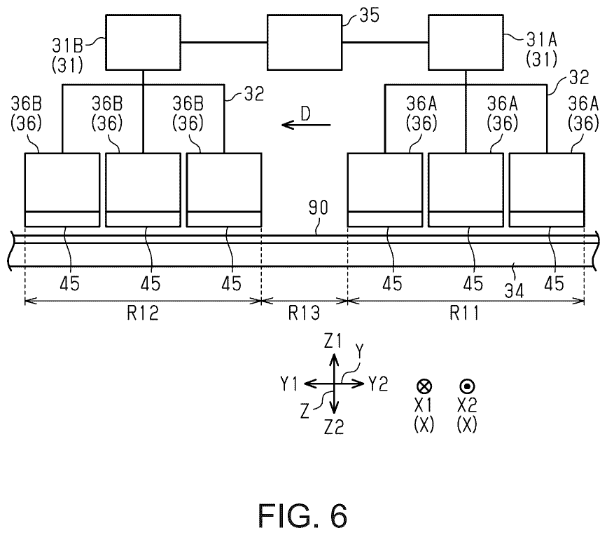

As shown in FIG. 6, in the second embodiment, in the drying device 12, the drying section 36 may include a first drying section 36A and a second drying section 36B. The drying section 36 may include a plurality of first drying sections 36A and a plurality of second drying sections 36B. That is, the drying device 12 may include the first drying section 36A and the second drying section 36B.

The first drying section 36A performs provisional drying of the medium 90 by generating electromagnetic waves. The first drying section 36A is provided in an upstream region R11. The upstream region R11 is positioned upstream of a downstream region R12 (to be described later) in the transport direction D.

The second drying section 36B performs main drying of the medium 90 by generating electromagnetic waves. The second drying section 36B is provided in the downstream region R12. As described above, the second drying section 36B is provided downstream of the first drying section 36A in the transport direction D. An intermediate region R13, in which electromagnetic waves are not generated, is provided between the upstream region R11 and the downstream region R12 in the transport direction D.

The first drying section 36A generates electromagnetic waves having a higher intensity than the second drying section 36B. In detail, by configuring the inductance of the coil 43A of the first drying section 36A and the inductance of the coil 43A of the second drying section 36B to be different from each other, the resonance frequencies of the first drying section 36A and the second drying section 36B can be made different from each other. As described above, by setting the resonance frequency of the first drying section 36A to be higher than the resonance frequency of the second drying section 36B, the intensity of the electromagnetic waves generated from the first drying section 36A can be made higher than the intensity of the electromagnetic waves generated from the second drying section 36B.

The high-frequency voltage generation section 31 may include a first high-frequency voltage generation section 31A and a second high-frequency voltage generation section 31B. The first high-frequency voltage generation section 31A supplies a high-frequency voltage to the first drying section 36A. The second high-frequency voltage generation section 31B supplies a high-frequency voltage to the second drying section 36B.

The control section 35 causes the drying transport section 33 to perform continuous transport for continuously transporting the medium 90. The control section 35 controls the first high-frequency voltage generation section 31A to generate an electromagnetic wave in the first drying section 36A based on a first control pattern while the medium 90 is continuously transported at a predetermined speed. By this, the first drying section 36A generates an electromagnetic wave based on the first control pattern in a state where the medium 90 is continuously transported at a predetermined speed.

The control section 35 controls the second high-frequency voltage generation section 31B to generate an electromagnetic wave in the second drying section 36B based on a second control pattern while the medium 90 is continuously transported at a predetermined speed. By this, the second drying section 36B generates an electromagnetic wave based on the second control pattern in a state where the medium 90 is continuously transported at a predetermined speed.

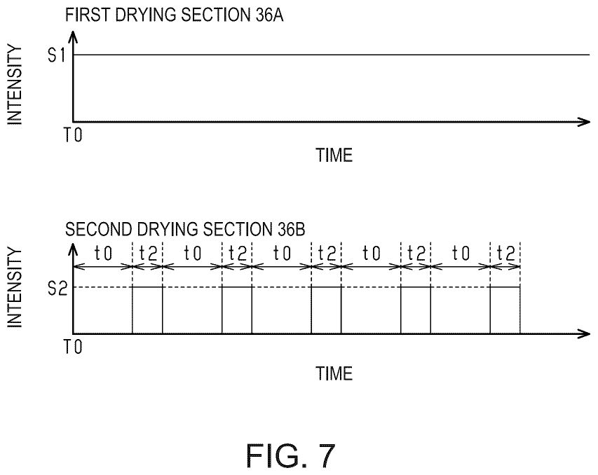

As shown in FIG. 7, the first control pattern is a pattern in which an electromagnetic wave of a predetermined intensity is continuously generated. The first control pattern is a pattern for controlling the first drying section 36A. Therefore, the first control pattern is a pattern in which an electromagnetic wave of first intensity S1 is continuously generated from the first drying section 36A. By this, the first drying section 36A continuously generates an electromagnetic wave at a predetermined intensity based on the first control pattern in a state in which the medium 90 is continuously transported at a predetermined speed.

The second control pattern is a pulsed pattern for generating an electromagnetic wave over a predetermined pulse width. The second control pattern is a pattern for controlling the second drying section 36B. For this reason, the second control pattern is a pattern in which an electromagnetic wave with second intensity S2 smaller than the first intensity S1 is generated in a pulse shape from the second drying section 36B. The predetermined pulse width may be the same as the second pulse width of the time t2, or it may be shorter or longer than the second pulse width. By this, the second drying section 36B generates a pulsed electromagnetic wave over a predetermined pulse width based on the second control pattern in a state where the medium 90 is continuously transported at a predetermined speed.

In this manner, the medium 90 is continuously transported at a predetermined speed along the transport direction D, and thus the first drying section 36A generates an electromagnetic wave at the first intensity S1 for a predetermined time with a region to be dried of the medium 90 arranged in the upstream region R11 as a target. The predetermined time may be the time t1. By this, in the upstream region R11, a region to be dried of the medium 90 is continuously irradiated with an electromagnetic wave from the first drying section 36A.

Thereafter, the medium 90 is transported such that a region to be dried of the medium 90 moves from the upstream region R11 to the intermediate region R13. A region to be dried of the medium 90 arranged in the intermediate region R13 is not irradiated with an electromagnetic wave for a predetermined period of time. The predetermined time may be the time to.

Subsequently, the medium 90 is transported such that a region to be dried of the medium 90 moves from the intermediate region R13 to the downstream region R12. The second drying section 36B repeats the generation of an electromagnetic wave at the second intensity S2 for a time corresponding to a predetermined speed and a predetermined pulse width over three cycles with respect to a region to be dried of the medium 90 arranged in the downstream region R12. By this, in the downstream region R12, a region to be dried of the medium 90 is irradiated with a pulsed electromagnetic wave from the second drying section 36B.

As described above, also in the second embodiment, as in the first embodiment, the drying section 36, including the first drying section 36A and the second drying section 36B, generates an electromagnetic wave so that the irradiation intensity of the electromagnetic wave in the medium 90 becomes pulsed in time series.

### Operations and Effects of Second Embodiment

Operations and effects of the second embodiment will be described.

(2-1) The first drying 36A generates an electromagnetic wave based on the first control pattern in a state in which the medium 90 is continuously transported at a predetermined speed. The first control pattern is a pattern in which an electromagnetic wave of a predetermined intensity is continuously generated. The second drying section 36B is provided downstream of the first drying section 36A in the transport direction D. The second drying g section 36B generates an electromagnetic wave based on the second control pattern in a state where the medium 90 is continuously transported at a predetermined speed. The second control pattern is a pulsed pattern for generating an electromagnetic wave over a predetermined pulse width. According to this configuration, it is possible to dry the medium 90 onto which pigment ink was ejected without stopping the transport of the medium 90. By this, it is possible to increase the speed of drying the medium 90 onto which pigment ink was ejected.

In addition to this, by generating an electromagnetic wave from the first drying section 36A, it is possible to increase the speed of raising the temperature of pigment ink ejected onto the medium 90. In addition, it is possible to suppress an excessive increase in the temperature of pigment ink ejected onto the medium 90 due to the generation of an electromagnetic wave from the second drying section 36B. By this, it is possible to suppress the occurrence of thermal denaturation with respect to the medium 90 onto which pigment ink was ejected. Therefore, it is possible to dry the medium 90 in a short time while maintaining the quality of the medium 90.

(2-2) The resonance frequency of the first drying section 36A is different from the resonance frequency of the second drying section 36B, and the first drying section 36A generates an electromagnetic wave with a higher intensity than the second drying section 36B. According to this configuration, by making the resonance frequency of the first drying section 36A different from the resonance frequency of the second drying section 36B, the first drying section 36A can generate an electromagnetic wave with a higher intensity than that of the second drying section 36B. Therefore, it is possible to further increase the speed at which the temperature of pigment ink ejected onto the medium 90 is raised by the generation of an electromagnetic wave from the first drying section 36A. Additionally, it is possible to further suppress an excessive increase in the temperature of pigment ink ejected onto the medium 90 due to the generation of an electromagnetic wave from the second drying section 36B. By this, it is possible to suppress the occurrence of thermal denaturation with respect to the medium 90 onto which pigment ink was ejected. Therefore, it is possible to dry the medium 90 in a short time while maintaining the quality of the medium 90. It is possible to reduce the control load for controlling the intensity of an electromagnetic wave generated by the first drying section 36A and the intensity of an electromagnetic wave generated by the second drying section 36B.

### Third Embodiment

Next, a third embodiment will be described.

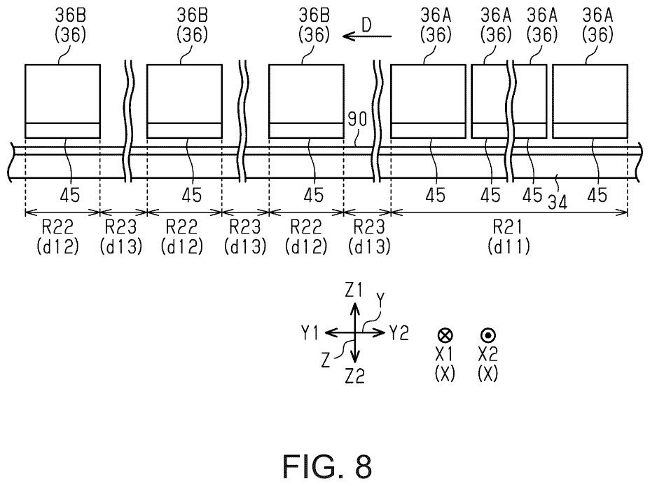

As shown in FIG. 8, in the third embodiment, the first drying section 36A is provided in a first region R21. The second drying section 36B is provided in a second region R22. The second region R22 is a region provided downstream of the first region R21 in the transport direction D. As described above, the second drying section 36B is provided downstream of the first drying section 36A in the transport direction D. The second region R22 may be provided at three positions downstream of the first region R21 in the transport direction D.

A third region R23 is provided between the first region R21 and the second region R22 in the transport direction D. The third region R23 is a region where electromagnetic waves are not generated. That is, the second region R22 is a region in which the third region R23 is provided between the second region R22 and the first region R21. A third region R23 is also provided between the second regions R22 in the transport direction D. That is, the second region R22 is a region in which the third region R23 is provided between the second regions R22.

The first region R21 is provided over a first distance d11 in the transport direction D. That is, the first distance d11 is the distance of the first region R21 in the transport direction D. The second region R22 is provided over a second distance d12 in the transport direction D. That is, the second distance d12 is the distance of the second region R22 in the transport direction D. The third region R23 is provided over a third distance d13 in the transport direction D. That is, the third distance d13 is the distance of the third region R23 in the transport direction D.

The first t distance d11 is longer than the second distance d12. The ratio of the first distance d11, the second distance d12, and the third distance d13 may be the same as the ratio of the time t1, the time t2, and the time to. For example, the ratio of the first distance d11, the second distance d12, and the third distance d13 may be 6:1:2.

The first distance d11 may be equal to the product of a predetermined speed at which the medium 90 is transported and the time t1. The second distance d12 may be equal to the product of a predetermined speed at which the medium 90 is transported and the time t2. The third distance d13 may be equal to the product of a predetermined speed at which the medium 90 is transported and the time t3.

The first drying section 36A and the second drying section 36B may be supplied with the same high-frequency voltage from the high-frequency voltage generation section 31. The control section 35 controls the high-frequency voltage generation section 31 to generate electromagnetic waves in the first drying section 36A and the second drying section 36B based on the control pattern.

The control section 35 causes the drying transport section 33 to perform continuous transport for continuously transporting the medium 90. The control section 35 controls the high-frequency voltage generation section 31 to generate electromagnetic waves in the first drying section 36A and the second drying section 36B based on the control pattern in a state in which the medium 90 is continuously transported at a predetermined speed. That is, the first drying section 36A and the second drying section 36B generate electromagnetic waves based on the control pattern in a state in which the medium 90 is continuously transported at a predetermined speed.

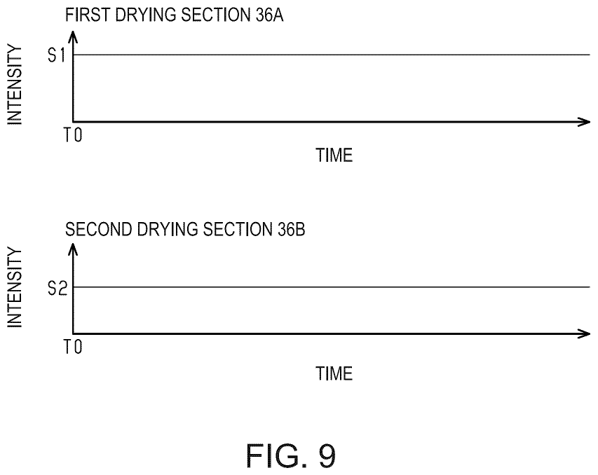

As shown in FIG. 9, the control pattern is a pattern in which an electromagnetic wave is continuously generated at a predetermined intensity. The control pattern is a pattern for controlling the first drying section 36A and the second drying section 36B. Therefore, the control pattern is a pattern in which an electromagnetic wave of the first intensity S1 is continuously generated from the first drying section 36A. The control pattern is a pattern in which an electromagnetic wave of the second intensity S2 is continuously generated from the second drying section 36B. By this, the first drying section 36A and the second drying section 36B continuously generate electromagnetic waves with a predetermined intensity based on the control pattern in a state in which the medium 90 is continuously transported at a predetermined speed.

In this manner, the medium 90 is continuously transported at a predetermined speed along the transport direction D, and thus the first drying section 36A generates an electromagnetic wave with the first intensity S1 for the time t1 with a region to be dried of the medium 90 arranged in the first region R21 as a target. By this, in the first region R21, an electromagnetic wave from the first drying section 36A are continuously radiated to a region to be dried of the medium 90.

Thereafter, the medium 90 is transported so that a region to be dried of the medium 90 moves from the first region R21 to the third region R23. A region to be dried of the medium 90 arranged in the third region R23 is not irradiated with an electromagnetic wave for the time to.

Subsequently, the medium 90 is transported so that a region to be dried of the medium 90 moves from the third region R23 to the second region R22. The second drying section 36B repeats the generation of an electromagnetic wave at the second intensity S2 for the time t2 on a region to be dried of the medium 90 arranged in the second region R22 for three cycles. By this, in the second region R22, a region to be dried of the medium 90 is irradiated with a pulsed electromagnetic wave from the second drying section 36B.

As described above, also in the third embodiment, as in the first embodiment and second embodiment, the drying section 36, including the first drying section 36A and the second drying section 36B, generates electromagnetic waves so that the irradiation intensity of the electromagnetic waves in the medium 90 becomes pulsed in time series.

### Operations and Effects of Third Embodiment

Operations and effects of a third embodiment will be described.

(3-1) The first drying section 36A is provided in the first region R21. The second drying section 36B is provided in a second region R22. The second region R22 is a region provided downstream of the first region R21 in the transport direction D. The second region R22 is a region in which the third region R23 in which an electromagnetic wave is not generated is provided between the second region R22 and the first region R21 in the transport direction D. The first distance d11 of the first region R21 in the transport direction D is longer than the second distance d12 of the second region R22 in the transport direction D. The first drying section 36A and the second drying section 36B generate electromagnetic waves based on the control pattern in a state in which the medium 90 is continuously transported at a predetermined speed. The control pattern is a pattern for continuously generating an electromagnetic wave of a predetermined intensity. According to this configuration, it is possible to dry the medium 90 onto which pigment ink was ejected without stopping the transport of the medium 90. By this, it is possible to increase the speed of drying the medium 90 onto which pigment ink was ejected.

In addition to this, by generating an electromagnetic wave from the first drying section 36A, it is possible to increase the speed of raising the temperature of pigment ink ejected onto the medium 90. In addition, it is possible to suppress an excessive increase in the temperature of pigment ink ejected onto the medium 90 due to the generation of an electromagnetic wave from the second drying section 36B. By this, it is possible to suppress the occurrence of thermal denaturation with respect to the medium 90 onto which pigment ink was ejected. Therefore, it is possible to dry the medium 90 in a short time while maintaining the quality of the medium 90.

By providing the first drying section 36A in the first region R21 and the second drying section 36B in the second region R22, the control load for controlling the first drying section 36A and the second drying section 36B can be reduced.

### Modifications

The present embodiment can be implemented with the following modifications. The present embodiment and the following modifications can be implemented in combination with each other within a technically compatible range.

In the second embodiment, one or more first drying sections 36A may be arranged in the depth direction Y in the upstream region R11. In the upstream region R11, one or more first drying sections 36A may be arranged in the width direction X. In each downstream region R12, one or more second drying sections 36B may be arranged in the depth direction Y. In each downstream region R12, one or more second drying sections 36B may be arranged in the width direction X.

In the second embodiment, the number of first drying sections 36A arranged in the depth direction Y in the upstream region R11 may be different from the number of second drying sections 36B arranged in the depth direction Y in each of the downstream regions R12. The number of first drying sections 36A arranged in the depth direction Y in the upstream region R11 may be greater than or less than the number of second drying sections 36B arranged in the depth direction Y in each of the downstream regions R12. The number of second drying sections 36B arranged in the depth direction Y in each of the downstream regions R12 may be different.

In the third embodiment, one or more first drying sections 36A may be arranged in the depth direction Y in the first region R21. In the first region R21, one or more first drying sections 36A may be arranged in the width direction X. In each second region R22, one or more second drying sections 36B may be arranged in the depth direction Y. In each second region R22, one or more second drying sections 36B may be arranged in the width direction X.

In the third embodiment, the number of first drying sections 36A arranged in the depth direction Y in the first region R21 may be different from the number of second drying sections 36B arranged in the depth direction Y in each of the second regions R22. The number of first drying sections 36A arranged in the depth direction Y in the first region R21 may be greater than or less than the number of second drying sections 36B arranged in the depth direction Y in each of the second regions R22. The number of second drying sections 36B arranged in the depth direction Y may be different in each of the second regions R22.

In the first embodiment, the control section 35 may continuously transport the medium 90. In the second embodiment and the third embodiment, the control section 35 may intermittently transport the medium 90.

In the first embodiment, the drying section 36 may generate an electromagnetic wave such that the intensity of an electromagnetic wave in provisional drying is higher than the intensity of an electromagnetic wave in main drying. The drying section 36 may generate an electromagnetic wave such that the intensity of an electromagnetic wave in provisional drying is lower than the intensity of an electromagnetic wave in main drying.

In the second embodiment and the third embodiment, the drying section 36 may generate an electromagnetic wave such that the intensity of an electromagnetic wave in provisional drying is the same as the intensity of an electromagnetic wave in main drying. In the second embodiment and the third embodiment, the drying section 36 may generate an electromagnetic wave such that the intensity of an electromagnetic wave in provisional drying is lower than the intensity of an electromagnetic wave in main drying. In these cases, the drying section 36 may dry the medium 90 onto which pigment ink was ejected by increasing the time for which an electromagnetic wave is generated as provisional drying.

The drying device 12 may perform main drying without performing provisional drying. In particular, in the first embodiment, the control pattern may be a pattern in which an electromagnetic wave is generated in a pulsed manner a plurality of times over a predetermined pulse width. In the second embodiment and the third embodiment, the drying device 12 may not include the first drying section 36A as long as the irradiation intensity of electromagnetic waves in the medium 90 onto which pigment ink was ejected is pulsed in time series. That is, the drying device 12 may include at least the second drying section 36B in a plurality of rows in the transport direction D as long as the irradiation intensity of electromagnetic waves in the medium 90 onto which pigment ink was ejected is pulsed in time series.

In the third embodiment, the third region R23 is a region where the drying section 36 is not arranged, but it may also be a region where the drying section 36 is arranged but where an electromagnetic wave is not generated from the drying section 36.

In main drying, an electromagnetic wave may be generated such that the irradiation intensity of the electromagnetic wave in the medium 90 is pulsed two times or four times or more in time series. That is, in main drying, two or four or more cycles may be repeatedly performed. It is sufficient that an electromagnetic wave is generated so that the irradiation intensity of the electromagnetic wave in the medium 90 becomes pulsed in time series at least in provisional drying and main drying. In this case, an electromagnetic wave may be generated in such a manner that the irradiation intensity of the electromagnetic wave in the medium 90 is pulsed only once in time series in main drying.

The control section 35 may control a high-frequency voltage supplied from the high-frequency voltage generation section 31 to the drying section 36 not by the high-frequency voltage generation section 31 but by the drying section 36 itself. Specifically, the drying section 36 may receive a high-frequency voltage based on the control pattern from the high-frequency voltage generation section 31 as long as an electromagnetic wave can be generated based on the control pattern. As long as the drying section 36 can generate an electromagnetic wave based on the control pattern, the drying section 36 may receive a high-frequency voltage from the high-frequency voltage generation section 31 and generate an electromagnetic wave as an envelope based on the control pattern.

The relationship between the high-frequency voltage generation section 31 and the drying section 36 may be one-to-many or one-to-one. In particular, in the second embodiment, the relationship between the first high-frequency voltage generation section 31A and the first drying section 36A may be one-to-many or one-to-one. In the second embodiment, the relationship between the second high-frequency voltage generation section 31B and the second drying section 36B may be one-to-many or one-to-one.

The drying section 36 may be arranged so that the depth direction Y is a longitudinal direction. The drying section 36 may be arranged so as to be inclined with respect to the width direction X and the depth direction Y.

In a case where the drying unit 30 includes a plurality of drying sections 36, the plurality of drying sections 36 may be arranged in a plurality of rows in the width direction X. In a case where the drying unit 30 includes a plurality of drying sections 36, the plurality of drying sections 36 may be arranged in a plurality of rows in the depth direction Y.

The drying section 36 may be provided on a back surface 90B side of the medium 90. The drying section 36 may be provided on both a front surface 90A side of the medium 90 and a back surface 90B side of the medium 90. The drying section 36 may be capable of scanning in the width direction X.

The drying section 36 may be provided separately from the facing section 45. That is, the drying section 36 may not include the facing section 45. In this case, it is desirable for the facing section 45 to be provided between the first electrode 41 and the second electrode 42, and the medium 90.

The first electrode 41 is not limited to a flat plate shape and may, for example, have a substantially flat plate shape. The substantially flat shape may include, for example, a shape curved in the thickness direction, which is a direction along the vertical direction Z, or a linear shape with an extremely large aspect ratio of a rectangular shape. The first electrode 41 may have a shape with a thickness in the vertical direction Z, and a plurality of electrode members may be connected in the vertical direction Z.

The second electrode 42 is not limited to a flat plate shape and may, for example, have a substantially flat plate shape. The substantially flat shape may include, for example, a shape curved in the thickness direction, which is a direction along the vertical direction Z, or a linear shape with an extremely large aspect ratio of a rectangular shape.

At least one of the first electrode surface 41A and the second electrode surface 42A is not limited to a planar shape, and may be a substantially planar shape. The substantially planar shape may include, for example, a shape curved in the thickness direction, which is a direction along the vertical direction Z, or a linear shape with an extremely large aspect ratio of a rectangular shape.

The drying section 36 may not be provided in the drying device 12 and may be provided in the recording device 11. That is, the recording device 11 may include the drying section 36. In this case, it is sufficient that the drying section 36 is provided on a downstream side of the recording section 20 in the transport direction D. In this manner, the drying section 36 may be applied to the recording device 11 instead of the drying device 12.

A lateral type printer may be adopted as the recording device 11. The lateral type printer is a printer in which carriage 25 can move in two directions, a main scanning direction and a sub-scanning direction.

The medium 90 is not limited to a roll body. The medium 90 may be a paper sheet, a resin film or sheet, a resin-metal composite film, a laminate film, a textile, a nonwoven fabric, a metal foil, a metal film, a ceramic sheet, a garment, or the like.

Liquid can be arbitrarily selected as long as it is pigment ink for recording on the medium 90 by depositing to medium 90. Pigment ink may contain a solvent other than glycerin. In such a case, the irradiation intensity of an electromagnetic wave in a medium may be varied depending on the boiling point of a solvent contained in pigment ink and the ratio of the solvent. Specifically, the irradiation intensity of electromagnetic waves in a medium can be adjusted by adjusting at least one of a first pulse width, a second pulse width, the number of times electromagnetic waves are generated with a second pulse width, the intensity with which electromagnetic waves are generated, and the number and arrangement of the drying section 36.

As used herein, the phrase “at least any” means one or more of the desired options. As an example, the phrase “at least any” as used herein means only one option if the number of options is two, or both of the two options. As another example, the phrase “at least any” as used herein means only one option or a combination of any two or more options when the number of options is three or more.

### Notes

Hereinafter, technical ideas grasped from the above-described embodiments and modifications, and operations and effects thereof will be described. The present technical ideas and the operations and effects thereof can be combined with each other within a technically consistent range.

(A) A drying device includes a drying section that dries a medium onto which pigment ink containing a pigment, water, and a solvent was ejected by generating an electromagnetic wave in response to application of a high-frequency voltage, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode and the drying section generates electromagnetic waves so that an irradiation intensity of the electromagnetic wave on a medium onto which pigment ink was ejected becomes pulsed in time series.

According to this configuration, a medium can be dried in a short time by generating an electromagnetic wave in response to application of a high-frequency voltage. In addition, even if the intensity of an electromagnetic wave is high, the irradiation intensity of the electromagnetic wave in the medium can be pulsed in time series. By this, it is possible to suppress the occurrence of thermal denaturation with respect to the medium onto which pigment ink was ejected. Therefore, it is possible to dry a medium in a short time while maintaining the quality of the medium.

(B) The above-described drying device may be configured such that the drying section generates an electromagnetic wave based on a control pattern and the control pattern is a pulsed pattern that generates an electromagnetic wave from a first start timing over a first pulse width, and generates an electromagnetic wave from a second start timing that is after the first start timing over a second pulse width that is shorter than the first pulse width.

According to this configuration, the generation timing of an electromagnetic wave can be controlled based on the control pattern. Therefore, the control accuracy of the temperature of pigment ink can be improved.

In particular, by generating an electromagnetic wave over the first pulse width from the first start timing, it is possible to increase the speed of raising the temperature of pigment ink ejected onto a medium. By generating an electromagnetic wave over the second pulse width that is shorter than the first pulse width from the second start timing after the first start timing, it is possible to suppress an excessive rise in the temperature of pigment ink ejected onto the medium. By this, it is possible to suppress the occurrence of thermal denaturation with respect to the medium onto which pigment ink was ejected. Therefore, it is possible to dry a medium in a short time while maintaining the quality of the medium.

(C) The above-described drying device may be configured such that the drying device further includes a drying transport section that transports a medium along a transport direction, wherein the drying transport section intermittently transports the medium along the transport direction and the drying section generates an electromagnetic wave based on the control pattern in a state in which a transport of the medium by the drying transport section is stopped.

According to this configuration, an electromagnetic wave can be generated based on the control pattern in a state in which a transport of the medium is stopped. Therefore, the control accuracy of the temperature of pigment ink can be improved. By this, it is possible to suppress the occurrence of thermal denaturation with respect to the medium onto which pigment ink was ejected. Therefore, it is possible to dry a medium in a short time while maintaining the quality of the medium.

(D) The above-described drying device may be configured such that the drying device further includes a drying transport section that transports a medium along a transport direction, wherein the drying section includes a first drying section and a second drying section provided downstream of the first drying section in the transport direction, the first drying section generates an electromagnetic wave based on a first control pattern in a state where the medium is continuously transported at a predetermined speed by the drying transport section, the second drying section generates an electromagnetic wave based on a second control pattern in a state where the medium is continuously transported at a predetermined speed by the drying transport section, the first control pattern is a pattern for continuously generating an electromagnetic wave of a predetermined intensity, and the second control pattern is a pulsed pattern that generates an electromagnetic wave over a predetermined pulse width.

According to this configuration, it is possible to dry a medium onto which pigment ink was ejected without stopping the transport of a medium. By this, it is possible to increase the speed of drying the medium onto which pigment ink was ejected.

In addition to this, it is possible to increase the speed of raising the temperature of pigment ink ejected onto the medium due to the generation of an electromagnetic wave from the first drying section. It is possible to suppress an excessive rise in the temperature of pigment ink ejected onto the medium due to the generation of an electromagnetic wave from the second drying section provided downstream of the first drying section in the transport direction. By this, it is possible to suppress the occurrence of thermal denaturation with respect to the medium onto which pigment ink was ejected. Therefore, it is possible to dry a medium in a short time while maintaining the quality of the medium.

(E) The above-described drying device may be configured such that the drying device further includes a drying transport section that transports a medium along a transport direction, wherein the drying section includes a first drying section and a second drying section provided downstream of the first drying section in the transport direction, the first drying section is provided in a first region, the second drying section is provided in a second region, the second region is a region provided downstream of the first region in the transport direction, and is a region in which a third region in which an electromagnetic wave is not generated is provided between the second region and the first region in the transport direction, a first distance of the first region in the transport direction is longer than a second distance of the second region in the transport direction, the first drying section and the second drying section generate electromagnetic waves based on a control pattern in a state where the medium is continuously transported at a predetermined speed by the drying transport section, and the control pattern is a pattern for continuously generating an electromagnetic wave of a predetermined intensity.

According to this configuration, it is possible to dry a medium onto which pigment ink was ejected without stopping the transport of a medium. By this, it is possible to increase the speed of drying the medium onto which pigment ink was ejected.

In addition to this, it is possible to increase the speed of raising the temperature of pigment ink ejected onto the medium due to the generation of an electromagnetic wave from the first drying section. It is possible to suppress an excessive rise in the temperature of pigment ink ejected onto the medium due to the generation of an electromagnetic wave from the second drying section provided downstream of the first drying section in the transport direction. By this, it is possible to suppress the occurrence of thermal denaturation with respect to the medium onto which pigment ink was ejected. Therefore, it is possible to dry a medium in a short time while maintaining the quality of the medium. Since the first drying section is provided in the first region and the second drying section is provided in the second region, it is possible to reduce the control load for controlling the first drying section and the second drying section.

(F) The above-described drying device may be configured such that a resonance frequency of the first drying section is different from a resonance frequency of the second drying section and the first drying section generates an electromagnetic wave having a higher intensity than the second drying section.

According to this configuration, by making the resonance frequency of the first drying section different from the resonance frequency of the second drying section, the first drying section can generate an electromagnetic wave with a higher intensity than that of the second drying section. For this reason, it is possible to further increase the speed at which the temperature of pigment ink ejected onto a medium is increased by the generation of an electromagnetic wave from the first drying section. In addition, it is possible to further suppress an excessive rise in the temperature of pigment ink ejected onto the medium due to the generation of an electromagnetic wave from the second drying section. By this, it is possible to suppress the occurrence of thermal denaturation with respect to the medium onto which pigment ink was ejected. Therefore, it is possible to dry a medium in a short time while maintaining the quality of the medium. It is possible to reduce the control load for controlling the intensity of an electromagnetic wave generated by the first drying section and the intensity of an electromagnetic wave generated by the second drying section.

(G) A recording device includes a recording section that performs recording by ejecting pigment ink containing a pigment, water, and a solvent onto a medium and a drying section that dries a medium onto which pigment ink was ejected by the recording section by generating an electromagnetic wave in response to application of a high-frequency voltage, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode and the drying section generates electromagnetic waves so that an irradiation intensity of the electromagnetic wave on a medium onto which pigment ink was ejected becomes pulsed in time series.

According to this configuration, the same effect as in (A) is obtained.

What is claimed is:

1. A drying device comprising:
a drying section that dries a medium onto which pigment ink containing a pigment, water, and a solvent was ejected by generating an electromagnetic wave in response to application of a high-frequency voltage, wherein
the drying section includes
a first electrode,
a second electrode arranged so as to surround the first electrode in plan view from a first direction toward a medium,
a first conductor that includes a coil and that electrically connects a transmission line, which is configured to transmit a high-frequency voltage, and the first electrode, and
a second conductor that electrically connects the transmission line and the second electrode and
the drying section generates electromagnetic waves so that an irradiation intensity of the electromagnetic wave on a medium onto which pigment ink was ejected becomes pulsed in time series.

2. The drying device according to claim 1, wherein
the drying section generates an electromagnetic wave based on a control pattern and
the control pattern is a pulsed pattern that generates an electromagnetic wave from a first start timing over a first pulse width, and generates an electromagnetic wave from a second start timing that is after the first start timing over a second pulse width that is shorter than the first pulse width.

3. The drying device according to claim 2, further comprising:
a drying transport section that transports a medium along a transport direction, wherein
the drying transport section intermittently transports the medium along the transport direction and
the drying section generates an electromagnetic wave based on the control pattern in a state in which a transport of the medium by the drying transport section is stopped.

4. The drying device according to claim 1, further comprising:
a drying transport section that transports a medium along a transport direction, wherein
the drying section includes a first drying section and a second drying section provided downstream of the first drying section in the transport direction,
the first drying section generates an electromagnetic wave based on a first control pattern in a state where the medium is continuously transported at a predetermined speed by the drying transport section,
the second drying section generates an electromagnetic wave based on a second control pattern in a state where the medium is continuously transported at a predetermined speed by the drying transport section,
the first control pattern is a pattern for continuously generating an electromagnetic wave of a predetermined intensity, and
the second control pattern is a pulsed pattern that generates an electromagnetic wave over a predetermined pulse width.

5. The drying device according to claim 1, further comprising:
a drying transport section that transports a medium along a transport direction, wherein
the drying section includes a first drying section and a second drying section provided downstream of the first drying section in the transport direction,
the first drying section is provided in a first region,
the second drying section is provided in a second region, the second region is a region provided downstream of the first region in the transport direction, and is a region in which a third region in which an electromagnetic wave is not generated is provided between the second region and the first region in the transport direction,
a first distance of the first region in the transport direction is longer than a second distance of the second region in the transport direction,
the first drying section and the second drying section generate electromagnetic waves based on a control pattern in a state where the medium is continuously transported at a predetermined speed by the drying transport section, and
the control pattern is a pattern for continuously generating an electromagnetic wave of a predetermined intensity.

6. The drying device according to claim 4, wherein
a resonance frequency of the first drying section is different from a resonance frequency of the second drying section and
the first drying section generates an electromagnetic wave having a higher intensity than the second drying section.

7. A recording device comprising:
a recording section that performs recording by ejecting pigment ink containing a pigment, water, and a solvent onto a medium and
a drying section that dries a medium onto which pigment ink was ejected by the recording section by generating an electromagnetic wave in response to application of a high-frequency voltage, wherein
the drying section includes
a first electrode,
a second electrode arranged so as to surround the first electrode in plan view from a first direction toward a medium,
a first conductor that includes a coil and that electrically connects a transmission line, which is configured to transmit a high-frequency voltage, and the first electrode, and
a second conductor that electrically connects the transmission line and the second electrode and
the drying section generates electromagnetic waves so that an irradiation intensity of the electromagnetic wave on a medium onto which pigment ink was ejected becomes pulsed in time series.
